(19) United States
(12) Patent Application Publication
(10) Pub. No.: US 2024/0296599 A1
(43) Pub. Date: Sep. 5, 2024

(54) SYSTEMS AND METHODS FOR DISPLAYING UPDATED VEHICLE INTERIORS

(71) Applicant: Toyota Connected North America, Inc., Plano, TX (US)

(72) Inventors: David Tsai, Irvine, CA (US); Shravanthi Denthumdas, Frisco, TX (US); Will Hargis, Celina, TX (US)

(73) Assignee: Toyota Connected North America, Inc., Plano, TX (US)

(21) Appl. No.: 18/177,827

(22) Filed: Mar. 3, 2023

(51) Int. Cl. G06T 11/00; G02B 27/01; G06F 3/01; G06V 20/59

(52) U.S. Cl. CPC G06T 11/001; G02B 27/0172; G06F 3/017; G06V 20/59; G02B 2027/0138; G02B 2027/014; G02B 2027/0141; G02B 2027/0178; G06T 2200/24

(57) ABSTRACT

In one embodiment, a system for modifying an appearance of a vehicle interior includes a display device including an electronic display operable to display images overlaid on the vehicle interior, a camera operable to acquire video data of the vehicle interior, one or more processors, and a computer-readable medium storing computer-readable instructions that cause the one or more processors to identify three or more reference fiducials within the vehicle interior using the video data, and display an updated interior image using the electronic display such that the updated image is overlaid on the vehicle interior, wherein the interior image comprises three or more image fiducials that are overlaid on the three or more reference fiducials and the updated interior image modifies the vehicle interior.

### TECHNICAL FIELD

The present specification relates to consumer vehicle evaluation and, more particularly, systems and methods for displaying updated vehicle interiors to a user

### BACKGROUND

Purchasing a new vehicle may be a significant life event for many people. Therefore, new vehicle purchasers typically like to sit in different vehicles and take the different vehicles for test drives to ensure that the vehicles they purchase are the right vehicles for them. A purchaser may like to sit in the driver's seat and make sure she likes the placement of the gauges, the design of the interior, and the functionality of the infotainment system, for example.

However, it may take significant time for a vehicle purchaser to test drive or otherwise sit in vehicles prior to a purchase. The vehicle purchaser may live far away from car dealerships, or the nearby car dealerships may not have the desired vehicle on the lot to test drive.

Accordingly, systems and methods for experiencing vehicle interiors may be desired.

### SUMMARY

In one embodiment, a system for modifying an appearance of a vehicle interior includes a display device including an electronic display operable to display images overlaid on the vehicle interior, a camera operable to acquire video data of the vehicle interior, one or more processors, and a computer-readable medium storing computer-readable instructions that cause the one or more processors to identify three or more reference fiducials within the vehicle interior using the video data, and display an updated vehicle interior using the electronic display such that the updated vehicle interior is overlaid on the vehicle interior, wherein the updated vehicle interior comprises three or more image fiducials that are overlaid on the three or more reference fiducials and the updated vehicle interior modifies the vehicle interior.

In another embodiment, a system for displaying a vehicle interior includes a vehicle interior mock-up including a driver seat and a passenger seat, a dashboard comprising one or more display surfaces, and three or more reference fiducials. The system further includes a display device including an electronic display operable to display images overlaid on the vehicle interior, and a camera operable to acquire video data of the vehicle interior. The system also includes one or more processors, and a computer-readable medium storing computer-readable instructions that cause the one or more processors to identify the three or more reference fiducials of the interior vehicle mock-up using the video data, and display an updated vehicle interior using the electronic display such that the updated vehicle interior is overlaid on at least one of the dashboard, the driver seat, and the passenger seat, wherein the updated vehicle interior comprises three or more image fiducials that are overlaid on the three or more reference fiducials and the updated vehicle interior modifies the vehicle interior.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 illustrates a physical vehicle interior according to one or more embodiments described and illustrated herein;

FIG. 2A illustrates a user using an example virtual reality headset according to one or more embodiments described and illustrated herein;

FIG. 2B illustrates a user using an example of augmented reality glasses according to one or more embodiments described and illustrated herein;

FIG. 3 illustrates an example updated vehicle interior projected onto a physical vehicle interior according to one or more embodiments described and illustrated herein;

FIG. 4 illustrates a side view of a vehicle interior mock-up according to one or more embodiments described and illustrated herein;

FIG. 5 illustrates an interior view of a vehicle interior mock-up according to one or more embodiments described and illustrated herein; and

FIG. 6 illustrates an example computing system for generating and displaying updated vehicle interiors according to one or more embodiments described and illustrated herein.

### DETAILED DESCRIPTION

The embodiments disclosed herein are directed to systems and methods for modifying an appearance of a vehicle interior. Generally, embodiments of the present disclosure utilize augmented reality to change the appearance of a vehicle in which a user is sitting in. In one non-limiting example, the vehicle in which the user is sitting in his or her current vehicle. In another non-limiting example, the vehicle is a mock-vehicle having smooth and white surfaces on which to project a vehicle interior ofa new vehicle. Such mock-vehicles may be at car dealerships, shopping districts, amusement parks, and/or the like. A display device, such as a projector, augmented reality glasses, virtual reality glasses, a tablet, and/or a smartphone may be used to display a vehicle interior of a new or different vehicle onto the interior of the vehicle in which the user is sitting. By using augmented reality (and/or virtual reality), a user may experience many different vehicle interiors in a short period of time, thereby making the vehicle buying process much for efficient and well-informed.

Various embodiments of systems and methods for modifying an appearance of a vehicle interior are described in detail below.

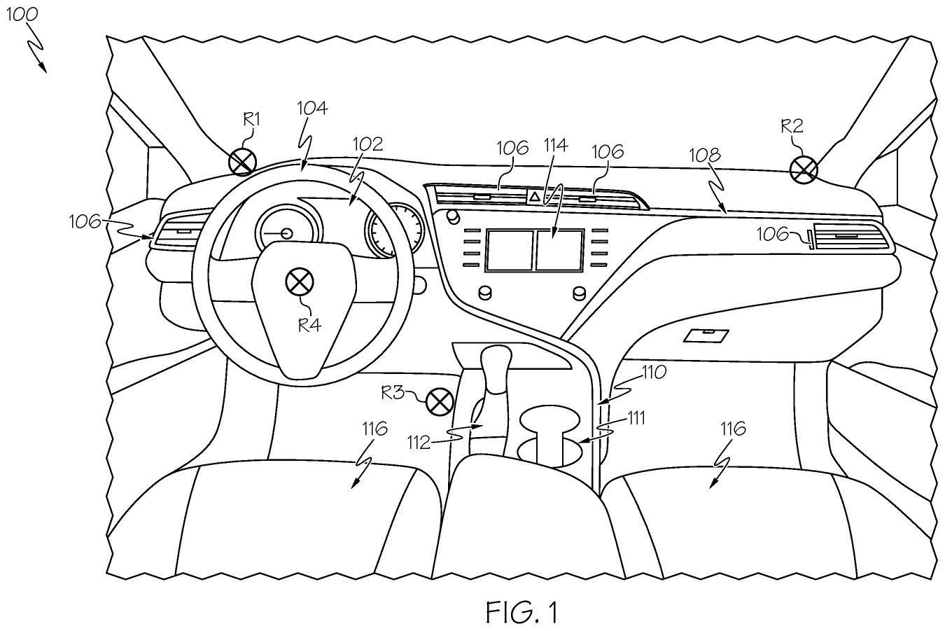

Referring now to FIG. 1, an example vehicle interior 100 of a vehicle that a user is physically sitting in. The vehicle may be owned by the user, and the user may be wanting to purchase a new vehicle. As stated above, embodiments of the present disclosure enable a user to experience different vehicle interiors while sitting within the vehicle interior 100 of a single physical vehicle.

The vehicle interior 100 may be an interior of any type of vehicle, such as, without limitation, a sedan, a hatchback, a sports car, a truck, a bus, and the like. It should be understood that although the figures illustrate the cockpit portion of the vehicle interior, embodiments of the present disclosure are not limited thereto. For example, the vehicle interior that is simulated may be from a second row or third row of seats of a vehicle.

Generally, the vehicle interior 100 may have two seats 116 (e.g., a driver's seat and a passenger's seat), a center console 110, a dashboard 101 and a steering wheel 104. The center console 110 may have a cup holder 117 and a shifter 112. The dashboard 101 may have various vents 106, an instrument cluster 102 having gauges, meters, and/or the like, a head unit 114 for displaying graphical user interfaces of an infotainment system, for example, and trim pieces 108. It should be understood that other non-numbered elements are present in the vehicle interior 100, such as a glove box, door handles, window controls, hazard lights button and many others. The presence, placement, and design of each feature create the overall design, look and feel of the vehicle interior 100. Luxury vehicles will have a different design, look and feel as compared to economy vehicles, for example.

The systems of the present disclosure generate augmented reality display content that is overlaid on the physical vehicle interior 100. Thus, the virtual features of the augmented reality vehicle interior, referred to herein as “updated vehicle interior” because it is updated from the physical vehicle interior 100 of the vehicle that the user is sitting in, should be placed in the accurate positions of the physical vehicle interior 100 as viewed by the user. Thus, in some embodiments, the system is configured to identify three or more reference fiducials within the physical vehicle 100. As described in more detail below, these reference fiducials are used by the system to accurately display the virtual features of the updated vehicle interior on the physical vehicle interior 100. The updated vehicle interior comprises three or more image reference fiducials that are overlaid on the three or more reference fiducials of the physical vehicle interior. The example physical interior 100 of FIG. 1 has four reference fiducials: a first reference fiducial R1 where the left A-pillar intersects the lower-left windshield, a second reference fiducial R2 where the right A-pillar intersects the lower-right windshield, a third reference fiducial R3 at the accelerator pedal, and a fourth reference fiducial R4 at the center of the steering wheel 104. It should be understood that any number of reference fiducials may be utilized. Three or more reference fiducials may be desirable to locate the various feature by triangulation. In some embodiments, each type of feature has a reference fiducial. For example, the center of the head unit 114 is used as a reference unit such that a virtual head unit of an updated vehicle interior may be displayed right over the physical head unit 114.

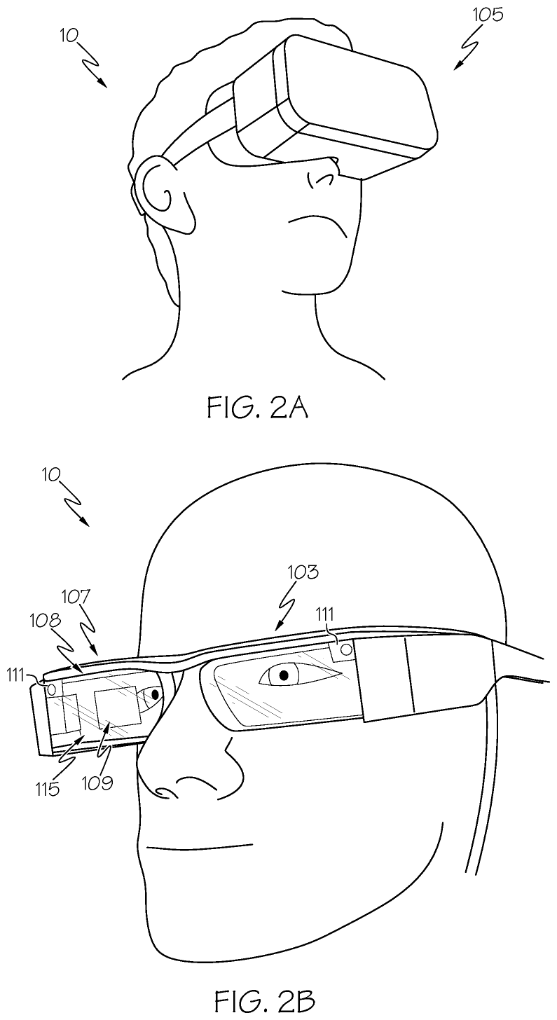

The systems of the present disclosure include a display device that renders an updated vehicle interior over the physical vehicle interior for the user. Many different display devices may be used, including, but not limited to, virtual reality headsets, augmented reality glasses, tablets, and smartphones. Referring now to FIG. 2A, an example display device configured as a virtual reality headset 105 worn by a user 10 is illustrated. The virtual reality headset 105 has interior displays that may display various vehicle interiors to the user. It is noted that when a virtual reality headset 105 is used, fiducials may or may not be located because the updated vehicle interior is not overlaid on a physical vehicle interior 100.

FIG. 2B illustrates a user 10 wearing augmented reality glasses 103 having one or more cameras 111 and one or more displays 113 within a frame 107 that project images 109 on one or both lenses 115. The augmented reality glasses 103 are operable to overlay images representing different vehicle interiors on top of a physical vehicle interior 100. As stated above, smartphones, tablets and other display devices may also be utilized.

The camera of the display device, such as the one or more cameras 111 of augmented reality glasses 103 generates image data of the vehicle interior 100 when the user 10 is sitting in the vehicle. The image data may be in the form of a video of the vehicle interior 100, for example. Referring once again to FIG. 1, the system is programmed to determine the locations of the reference fiducials in the image data captured by the one or more cameras 111. The reference fiducials may be detected using any method. As one non-limiting example, one or more object recognition algorithms may be used to recognize the fiducials, such as, without limitation, edge detection algorithms, corner detection algorithms, and feature description algorithms. Thus, the system is programmed to recognize the reference fiducial regions. For example, the system may recognize the first reference fiducial R1 as the intersection between the left A-pillar and the lower left corner of the windshield, and may recognize the fourth reference fiducial R4 as the center region of the steering wheel.

The reference fiducials are also used by the system to locate the position of the head of the user 10 within the vehicle interior 100. When the user 10 moves his or her head, the position of the reference fiducials in the image data changes.

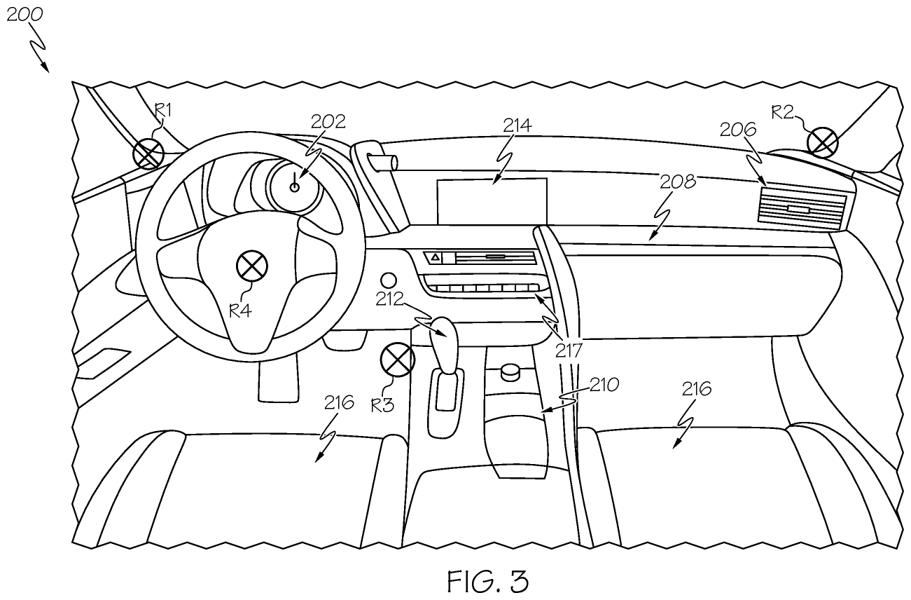

As stated above, embodiments of the present disclosure enable a user to view various vehicle interiors different from the physical vehicle interior of the vehicle she is sitting in. Referring now to FIG. 3, an updated vehicle interior 200 is overlaid on the physical vehicle interior 100 of FIG. 1 by the display device. The updated vehicle interior 200 has two seats 216 (e.g., a driver's seat and a passenger's seat), a center console 210, a dashboard 201 and a steering wheel 204. The center console 210 has a shifter 112 and may have a cup holder (that is concealed by a cover). The dashboard 101 has various vents 106, an instrument cluster 202 having gauges, meters, and/or the like, a head unit 214 for displaying graphical user interfaces of an infotainment system, for example, and a trim pieces 208. The updated vehicle interior 200 also includes a plurality of control buttons 217 under the head unit 214.

A comparison between FIGS. 1 and 3 reveal that the updated vehicle interior 200 is different from the physical vehicle interior 100. The arrangement and design of the various features are much different between the two interiors. As an example, the physical vehicle interior 100 may be of an economy vehicle and the updated vehicle interior may be of a luxury vehicle.

The display representing the updated vehicle interior 200 is overlaid on the physical vehicle interior 100 using the reference fiducials. Thus, the updated vehicle interior 200 is sized appropriately for the physical vehicle interior in which the user 10 is sitting. As a user 10 turns his or her head, the display of the updated vehicle interior 200 changes with the motion of the head so that it is overlaid on the proper locations within the physical vehicle interior 100. The reference fiducials aid in the placement of the updated vehicle interior 200 on the physical vehicle interior 100 as the user moves about the physical vehicle interior 100.

The display device (e.g., augmented reality glasses 103) or another computing device (e.g., a smartphone working in conjunction with the display device) may display a menu from which a user may select different vehicle interiors to virtually experience the different vehicle interiors. For example, the menu may be organized by vehicle style, model and trim level. In some embodiments, the system automatically changes the updated vehicle interior 200 every few minutes so that the user can experience the different vehicle interiors without having to manually switch them. As another example, the user may provide feedback using the display device, another computing device, or the physical vehicle's hardware. As a non-limiting example, the user may audibly say “I really like the color of the interior,” or “I can't see the head unit.” The user can also save different vehicle interiors to revisit later.

The user 10 may also be able to select and change different options, such as upholstery color, trim color, floor mats, and the like. Many updated interior options may be displayed for selection by the user.

In some embodiments, a virtual test drive may be provided to the user 10 in the physical vehicle interior 100. For example, a simulated environment may be overlaid on the windshield and the windows to give the user the impression that she is physically moving and driving the vehicle. A turning of the physical steering wheel may make a corresponding turn in the simulated virtual environment that is displayed. In this manner, the user 10 may take a virtual test drive of the vehicle while viewing the updated vehicle interior.

In some embodiments, manipulation of features in the updated vehicle interior 200 will control vehicle features in the physical vehicle. The one or more cameras 111 of the display device may monitor gestures of the user's hand, and the system may be programmed to detect certain user gestures. The system may be communicably coupled to the control system of the physical vehicle such that actions taken on features of the updated vehicle interior 200 (e.g., input devices such as touch screens, buttons, knobs and the like) by gestures cause real-world actions. For example, when a user moves her finger to the location of the horn button in the updated vehicle interior 200, the horn of the physical vehicle will sound. As another example, the updated vehicle interior 200 may display a list of songs on the head unit which are not displayed on the physical head unit. When the user moves her finger toward an individual song, that song will be played by the physical vehicle. Thus, the selection of a song produces using the updated vehicle interior produces audio data comprising information, and an audio signal corresponding to the audio data is received and played by an audio device of the vehicle (e.g., a speaker).

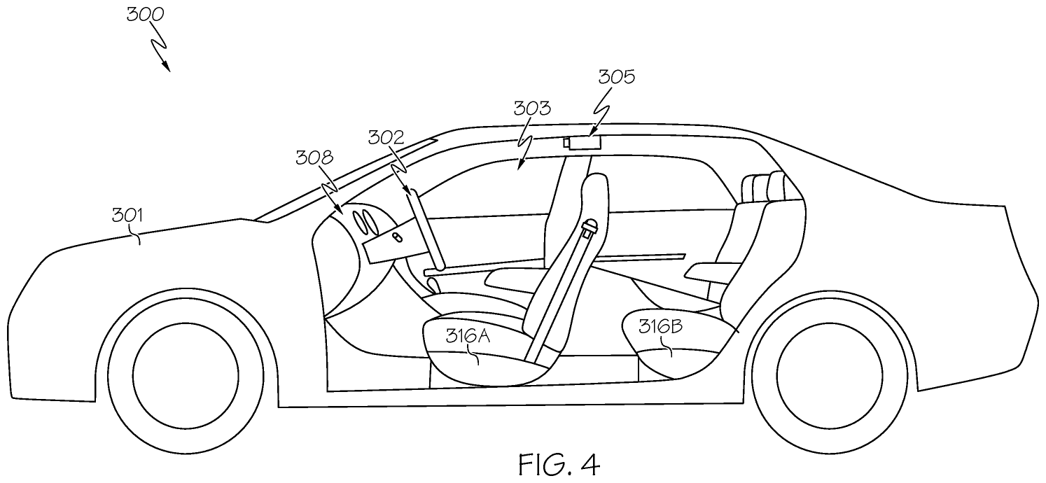

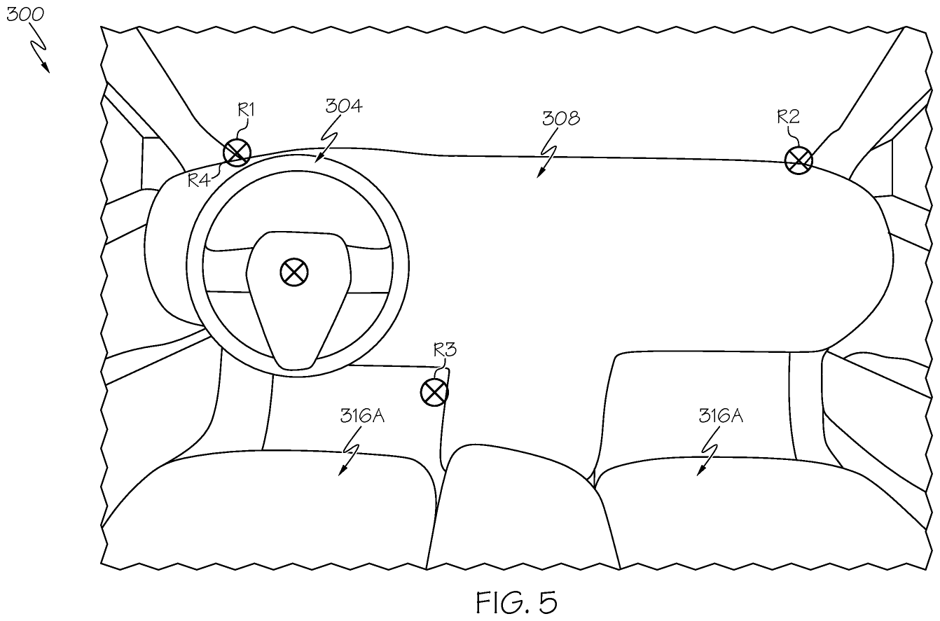

In some embodiments, the system includes a vehicle interior mock-up 300, as shown in FIGS. 4 and 5. The vehicle interior mock-up 300 is a device that simulates a vehicle interior 303. FIG. 4 is a side view of the vehicle interior mock-up 300 and FIG. 5 is a left front seat view of a dashboard 308 of the vehicle interior mock-up 300 shown in FIG. 4. The vehicle interior mock-up 300 may be located at a car dealership, at a shopping center, at an amusement park, at a festival or special event, and/or any other location where people congregate.

The vehicle interior mock-up 300 is configured to replicate a real vehicle interior; however, the surfaces of a vehicle interior mock-up 300 may be a white color and generally free of contours and features such that they act as projection surfaces onto which an updated vehicle interior may be projected and displayed. As used herein, “white color” means each of the red, green and blue values of a RGB code are within a range of 220 and 255, including endpoints. Referring to both FIGS. 4 and 5, the vehicle interior mock-up 300 has a body 301 (FIG. 4) that supports a vehicle interior 303 having features such as front seats 316A, back seats 316B, a dashboard 308, a steering wheel 302 and any other features. The body may be made of molded plastic, fiberglass, metal, and/or any other material capable of supporting users sitting within the vehicle interior mock-up 300.

In some embodiments, one or more surfaces of the vehicle interior mock-up 300 may three-dimensionally morph according to the shapes of the updated vehicle interior. For example, ridges, buttons, knobs and other features may physically appear in the surfaces of the vehicle interior mock-up 300, such as the dashboard. This may provide a more realistic updated vehicle interior. As an example, the dashboard 308 may be made of a shape-memory material, or a compliant material having actuators beneath it to push it up and down. Any known or yet-to-be-developed morphing surface may be utilized.

As stated above, the surfaces of the features of the vehicle interior mock-up 300 may be a white color and smooth without significant contours and shapes to provide a projection surface. As shown in FIG. 5, the dashboard 308 is free from a head unit, control buttons, vents and an instrument cluster. The surface is a white color so that features such as a head unit, instrument cluster and the like may be projected onto the dashboard 308.

Referring to FIG. 4, the vehicle interior mock-up 300 may include one or more projectors 305 to project different updated vehicle interiors onto the surfaces of the vehicle interior mock-up 300, such as the dashboard 308. The one or more projectors 305 may be placed on the headliner of the vehicle interior mock-up 300, and/or other locations throughout the cabin. The one or more projectors 305 may also include a camera feature to capture video and/or image data of the vehicle interior mock-up 300.

In some embodiments, no projectors 305 are provided. Rather, a display device is used to overlay the updated vehicle interiors onto the surfaces of the vehicle interior mock-up 300, such as the augmented reality glasses 103 shown in FIG. 2B. The vehicle interior mock-up 300 includes reference fiducials as described above. Because the vehicle interior mock-up 300 is a dedicated space to display updated vehicle interiors, the reference fiducials may include physical markings, such as QR codes, infrared-reflective paint markings, and/or the like.

The vehicle interior mock-up 300 may include a sound system including speakers such that the user can interact with a virtual head unit to perform tasks such as selecting a song or radio station, changing the volume, changing the equalizer, and/or the like.

As in the physical vehicle embodiments, the one or more projectors 305 may display an environment through the windshield and/or windows up based at least in part on inputs from one or more of the steering wheel, the brake pedal, the accelerator pedal, and the shifting device to simulate a driving experience.

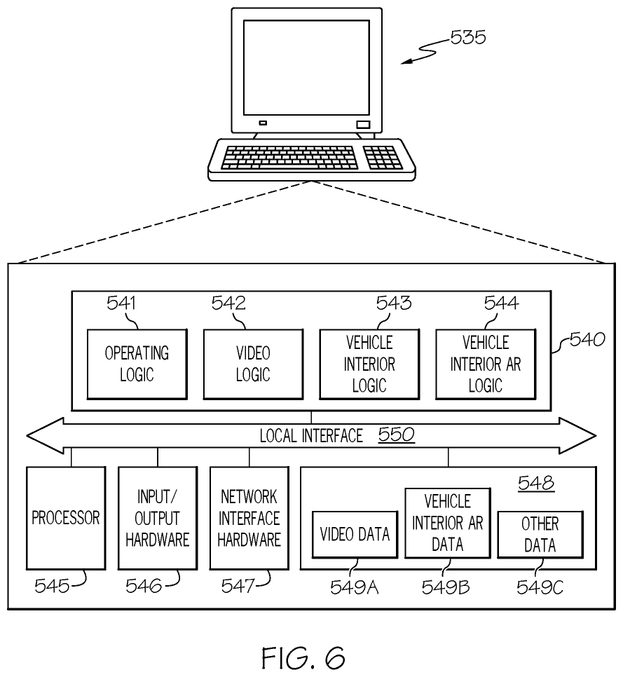

Embodiments of the present disclosure may be implemented by a computing device, and may be embodied as computer-readable instructions stored on a non-transitory memory device. Referring now to FIG. 6, an example system for managing virtual vehicles as a computing device 535 is schematically illustrated. The example computing device 535 provides a system displaying updated vehicle interiors, and/or a non-transitory computer usable medium having computer readable program code for displaying updated vehicle interiors embodied as hardware, software, and/or firmware, according to embodiments shown and described herein. While in some embodiments, the computing device 535 may be configured as a general purpose computer with the requisite hardware, software, and/or firmware, in some embodiments, the computing device 535 may be configured as a special purpose computer designed specifically for performing the functionality described herein. It should be understood that the software, hardware, and/or firmware components depicted in FIG. 6 may also be provided in other computing devices external to the computing device 535 (e.g., data storage devices, remote server computing devices, and the like).

As also illustrated in FIG. 6, the computing device 535 (or other additional computing devices) may include a processor 545, input/output hardware 546, network interface hardware 547, a data storage component 548 (which may include video data 549A (e.g., video data of a physical vehicle interior captured by one or more cameras), vehicle interior data 549B (e.g., data relating to displaying the updated vehicle interiors), and any other data 549C for performing the functionalities described herein), and a non-transitory memory component 540. The memory component 540 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 540 may be configured to store operating logic 541, video logic 542 for receiving and processing video data from one or more cameras, vehicle interior logic 543 for creating the various updated vehicle interiors, and vehicle interior augmented reality logic 544 for displaying the updated vehicle interiors onto a physical vehicle interior or vehicle interior mock-up (each of which may be embodied as computer readable program code, firmware, or hardware, as an example). It should be understood that the data storage component 548 may reside locally to and/or remote from the computing device 535, and may be configured to store one or more pieces of data for access by the computing device 535 and/or other components.

A local interface 550 is also included in FIG. 6 and may be implemented as a bus or other interface to facilitate communication among the components of the computing device 535.

The processor 545 may include any processing component configured to receive and execute computer readable code instructions (such as from the data storage component 548 and/or memory component 540). The input/output hardware 546 may include a virtual reality headset, augmented reality headset, smartphone, tablet, graphics display device, keyboard, mouse, printer, camera, microphone, speaker, touch-screen, and/or other devices for receiving, sending, and/or presenting data. The network interface hardware 547 may include any wired or wireless networking hardware, such as a modem, LAN port, wireless fidelity (Wi-Fi) card, WiMax card, mobile communications hardware, and/or other hardware for communicating with other networks and/or devices. The network interface hardware 547 may communicate via the Internet to receive vehicle data provided from one or more sources as well as communicate with a display device, such as augmented reality glasses 103 to display the updated vehicle interiors.

The components illustrated in FIG. 6 are merely exemplary and are not intended to limit the scope of this disclosure. More specifically, while the components in FIG. 6 are illustrated as residing within the computing device 535, this is a non-limiting example. In some embodiments, one or more of the components may reside external to the computing device 535.

It should now be understood that embodiments of the present disclosure are directed to systems and methods for displaying updated vehicle interiors onto an existing physical vehicle interior or a vehicle interior mock-up. Embodiments enable a user to “sit in” and experience many different vehicle interiors from their own vehicles or a mock-up, thereby saving significant time. Users may save preferences and generate their own interior combinations to view.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A system for modifying an appearance of a vehicle interior comprising:
a display device comprising:
an electronic display operable to display images overlaid on the vehicle interior;
a camera operable to acquire video data of the vehicle interior;
one or more processors; and
a computer-readable medium storing computer-readable instructions that cause the one or more processors to:
identify three or more reference fiducials within the vehicle interior using the video data; and
display an updated vehicle interior using the electronic display such that the updated vehicle interior is overlaid on the vehicle interior, wherein the updated vehicle interior comprises three or more image fiducials that are overlaid on the three or more reference fiducials and the updated vehicle interior modifies the vehicle interior.

2. The system of claim 1, wherein the updated vehicle interior changes an upholstery color of upholstery of the vehicle interior.

3. The system of claim 1, wherein the updated vehicle interior comprises a virtual head unit comprising a plurality of input devices, and the computer-readable instructions further cause the one or more processors to:
determine a user gesture using the video data that manipulates an individual input device of the plurality of input devices; and
operate a vehicle function corresponding to the manipulated individual input device of the plurality of input devices.

4. The system of claim 1, wherein the three or more reference fiducials comprise a lower left windshield fiducial, a lower right windshield fiducial, and a head unit center fiducial.

5. The system of claim 4, wherein the lower left windshield fiducial is located at a lower left corner of a windshield and the lower right windshield fiducial is located at a lower right corner of the windshield.

6. The system of claim 4, wherein the three or more reference fiducials further comprises a center of an accelerator pedal.

7. The system of claim 1, wherein the computer-readable instructions further cause the one or more processors to:
display a plurality of updated interior options for display;
receive a selection of a selected updated interior option of the plurality of updated interior options; and
update the updated vehicle interior such that the electronic display displays the selected updated interior option.

8. The system of claim 1, further comprising an audio device, wherein the computer-readable instructions further cause the one or more processors to receive audio data comprising information regarding the updated vehicle interior, and produce an audio signal corresponding to the audio data using the audio device.

9. A system for displaying a vehicle interior comprising:
a vehicle interior mock-up comprising:
a driver seat and a passenger seat;
a dashboard comprising one or more display surfaces; and
three or more reference fiducials;
a display device comprising:
an electronic display operable to display images overlaid on the vehicle interior; and
a camera operable to acquire video data of the vehicle interior;
one or more processors; and
a computer-readable medium storing computer-readable instructions that cause the one or more processors to:
identify the three or more reference fiducials of the vehicle interior mock-up using the video data; and
displaying an updated vehicle interior using the electronic display such that the updated vehicle interior is overlaid on at least one of the dashboard, the driver seat, and the passenger seat, wherein the updated vehicle interior comprises three or more image fiducials that are overlaid on the three or more reference fiducials and the updated vehicle interior modifies the vehicle interior.

10. The system of claim 9, wherein the display device comprises one or more projectors that project the updated vehicle interior onto at least one of the dashboard, the driver seat, and the passenger seat.

11. The system of claim 9, wherein the dashboard is a white color.

12. The system of claim 9, wherein the updated vehicle interior displays a virtual head unit comprising a plurality of input devices, and the computer-readable instructions further cause the one or more processors to:
determine a user gesture using the video data that manipulates an individual input device of the plurality of input devices; and
operate a vehicle function corresponding to the manipulated individual input device of the plurality of input devices.

13. The system of claim 9, wherein the three or more reference fiducials comprise a lower left windshield fiducial, a lower right windshield fiducial, and a head unit center fiducial.

14. The system of claim 13, wherein the lower left windshield fiducial is located at a lower left corner of a windshield and the lower right windshield fiducial is located at a lower right corner of the windshield of the vehicle interior mock-up.

15. The system of claim 13, wherein the three or more reference fiducials further comprises a center of an accelerator pedal.

16. The system of claim 9, wherein the computer-readable instructions further cause the one or more processors to:
display a plurality of updated interior options for display;
receive a selection of a selected updated interior option of the plurality of updated interior options; and
update the updated vehicle interior such that the electronic display displays the selected updated interior option.

17. The system of claim 9, further comprising an audio device, wherein the computer-readable instructions further cause the one or more processors to receive audio data comprising information regarding the updated vehicle interior, and produce an audio signal corresponding to the audio data using the audio device.

18. The system of claim 9, wherein the vehicle interior mock-up further comprises a steering wheel, a brake pedal, and an accelerator pedal.

19. The system of claim 18, wherein the computer-readable instructions further cause the one or more processors to display an environment at a windshield of the vehicle interior mock-up based at least in part on inputs from one or more of the steering wheel, the brake pedal, and the accelerator pedal.

20. The system of claim 9, wherein the passenger seat is a front passenger seat, and the vehicle interior mock-up further comprises one or more rear passenger seats.
